(19) United States
(12) Patent Application Publication
(10) Pub. No.: US 2026/0285158 A1
(43) Pub. Date: Sep. 24, 2026

(54) DISPLAY DEVICE, DISPLAY METHOD, STORAGE MEDIUM

(71) Applicant: HONDA MOTOR CO., LTD., Tokyo (JP)

(72) Inventors: Kazuki Kamata, Tokyo (JP); Tomotaka Teramachi, Tokyo (JP); Yugo Kajiwara, Tokyo (JP); Yuta Inaba, Tokyo (JP)

(21) Appl. No.: 19/544,066

(22) Filed: Feb. 19, 2026

(30) Foreign Application Priority Data
Mar. 19, 2025 (JP) 2025-044860

(51) Int. Cl. B60K 35/81; B60K 35/22; B60K 35/28

(52) U.S. Cl. CPC B60K 35/81; B60K 35/22; B60K 35/28; B60K 2360/166

(57) ABSTRACT

A display device includes a display and a display control unit configured to display surrounding conditions of a vehicle on the display. The display control unit executes displaying on the display, as the surrounding conditions, among a plurality of lanes formed on a road on which the vehicle is present, a host lane that is a lane in which the vehicle is present, an adjacent lane that is a lane adjacent to the host lane, and guidance information for guiding an occupant of the vehicle to a position of a recommended lane, which is a lane in which the vehicle is recommended to travel, determining a position of the guidance information to be displayed on the display based on the number of scheduled lane changes, which is the number of lane changes scheduled to be performed before the vehicle is moved from the host lane to the recommended lane, displaying the guidance information on the adjacent lane when the number of scheduled lane changes is one, and displaying the guidance information in an area outside the adjacent lane where the host lane is not present when the number of scheduled lane changes is two or more.

### CROSS-REFERENCE TO RELATED APPLICATION

This application is based upon and claims the benefit of priority from Japanese Patent Application No. 2025-044860, filed Mar. 19, 2025, the entire content of which is incorporated herein by reference.

### BACKGROUND

### Field Of The Invention

The present invention relates to a display device, a display method, and a storage medium.

### Description of Related Art

In recent years, efforts to provide access to sustainable transportation systems that have considered vulnerable traffic participants have been gaining momentum. To realize this goal, research and development for further improving traffic safety and convenience through research and development of automated driving technologies have been focused on. Driving assistance technologies include a technology that displays a plurality of lanes on a road on which a host vehicle is traveling, and also displays a mark (recommended lane mark) indicating which of the plurality of those lanes is a recommended lane (for example, refer to Japanese Unexamined Patent Application, First Publication No. 2020-41914).

### SUMMARY

In conventional technologies, a recommended lane may not be adjacent to a lane in which the host vehicle is traveling, but may be present to be separated by one or more lanes. In such cases, the recommended lane mark is also displayed at an interval of one or more lanes. Furthermore, as the host vehicle moves between lanes, a display position of the recommended lane mark moves to be closer to a host lane. In this manner, the display position of the recommended lane mark also moves as the host vehicle moves between lanes, thereby gradually expressing that the recommended lane is approaching the host lane.

However, in the conventional technologies, since all lanes are displayed on a display and the display position of the recommended lane mark is gradually moved, due to limitations on a size of a screen of the display, a width of each lane tends to narrow, making it difficult to discern a position of the recommended lane. Moreover, a display with a larger screen size is required to display the width of each lane more clearly.

To solve the issues described above, the present invention aims to provide occupants with clear guidance to the position of a recommended lane while making maximum effective use of a display screen, which has a limited size. This will ultimately contribute to a development of sustainable transportation systems.

The display device, display method, and storage medium according to the present invention have the following configuration.
(1) According to one aspect of the present invention, a display device includes a display, and a display control unit configured to display surrounding conditions of a vehicle on the display, in which the display control unit executes displaying on the display, as the surrounding conditions, among a plurality of lanes formed on a road on which the vehicle is present, a host lane that is a lane in which the vehicle is present, an adjacent lane that is a lane adjacent to the host lane, and guidance information for guiding an occupant of the vehicle to a position of a recommended lane, which is a lane in which the vehicle is recommended to travel, determining a position of the guidance information to be displayed on the display based on the number of scheduled lane changes, which is the number of lane changes scheduled to be performed before the vehicle is moved from the host lane to the recommended lane, displaying the guidance information on the adjacent lane when the number of scheduled lane changes is one, and displaying the guidance information in an area outside the adjacent lane where the host lane is not present when the number of scheduled lane changes is two or more.
(2) According to a second aspect of the present invention, in the first aspect, the display control unit may continue to display the guidance information in the area regardless of the number of lane changes when the number of scheduled lane changes is two or more.
(3) According to a third aspect of the present invention, in the second aspect, the display control unit, when the number of scheduled lane changes is three or more, may cause the position of the guidance information displayed on the display after a first lane change is executed by the vehicle to be the same as the position of the guidance information displayed on the display before the first lane change is executed by the vehicle.
(4) According to a fourth aspect of the present invention, in the third aspect, the display control unit may display the guidance information on the adjacent lane when a difference between the number of scheduled lane changes and the number of executed lane changes, which is the number of times the lane change is executed by the vehicle, is one.
(5) According to a fifth aspect of the present invention, in the fourth aspect, the display control unit may further display marking lines of each of the host lane and the adjacent lane and the vehicle on the display, move the marking lines on the display as the lane change is executed by the vehicle, move the marking lines and the guidance information when the number of scheduled lane changes is two and the difference between the number of scheduled lane changes and the number of executed lane changes is one, and move the marking lines while guidance information is not moved when the number of scheduled lane changes is three or more and the difference between the number of scheduled lane changes and the number of executed lane changes is two or more.
(6) According to a sixth aspect of the present invention, a display method using a computer mounted in a vehicle including a display includes displaying surrounding conditions of the vehicle on the display, displaying on the display, as the surrounding conditions, among a plurality of lanes formed on a road on which the vehicle is present, a host lane that is a lane in which the vehicle is present, an adjacent lane that is a lane adjacent to the host lane, and guidance information for guiding an occupant of the vehicle to a position of a recommended lane, which is a lane in which the vehicle is recommended to travel, determining a position of the guidance information to be displayed on the display based on the number of scheduled lane changes, which is the number of lane changes scheduled to be performed before the vehicle is moved from the host lane to the recommended lane, displaying the guidance information on the adjacent lane when the number of scheduled lane changes is one, and displaying the guidance information in an area outside the adjacent lane where the host lane is not present when the number of scheduled lane changes is two or more.
(7) According to a seventh aspect of the present invention, a non-transitory storage medium stores a program for causing a computer mounted in a vehicle including a display to execute displaying surrounding conditions of the vehicle on the display, displaying on the display, as the surrounding conditions, among a plurality of lanes formed on a road on which the vehicle is present, a host lane that is a lane in which the vehicle is present, an adjacent lane that is a lane adjacent to the host lane, and guidance information for guiding an occupant of the vehicle to a position of a recommended lane, which is a lane in which the vehicle is recommended to travel, determining a position of the guidance information to be displayed on the display based on the number of scheduled lane changes, which is the number of lane changes scheduled to be performed before the vehicle is moved from the host lane to the recommended lane, displaying the guidance information on the adjacent lane when the number of scheduled lane changes is one, and displaying the guidance information in an area outside the adjacent lane where the host lane is not present when the number of scheduled lane changes is two or more.

According to the aspects described above, it is possible to provide occupants with clear guidance to a position of a recommended lane while making maximum effective use of a display screen, which has a limited size.

### BRIEF DESCRIPTION OF THE DRAWINGS

FIG. 1 is a configuration diagram of a vehicle system using a display device according to an embodiment.

FIG. 2 is a diagram which schematically shows an appearance of an interior of a host vehicle.

FIG. 3 is a functional configuration diagram of a first control unit, a second control unit, and a third control unit according to the embodiment.

FIG. 4 is a flowchart which shows an example of a flow of a series of processing performed by an automated driving control device according to the embodiment.

FIG. 5 is a diagram which represents an example of a situation in which a predetermined branch point is present ahead of a host vehicle traveling on a main road.

FIG. 6 is a diagram which represents an example of a screen of a first display in a scene S1-1.

FIG. 7 is a diagram which represents an example of the screen of the first display in a scene S1-2.

FIG. 8 is a diagram which represents an example of the screen of the first display in a scene S1-3.

FIG. 9 is a diagram which represents another example of a situation in which a predetermined branch point is present ahead of the host vehicle traveling on the main road.

FIG. 10 is a diagram which represents an example of the screen of the first display in a scene S2-1.

FIG. 11 is a diagram which represents an example of the screen of the first display in a scene S2-2.

FIG. 12 is a diagram which represents an example of the screen of the first display in a scene S2-3.

### DESCRIPTION OF EMBODIMENTS

Embodiments of the display device, display method, and storage medium of the present invention will be described below with reference to the drawings.

The display device of the embodiment is mounted, for example, in an automated driving vehicle. Automated driving refers to controlling driving of a vehicle by controlling one or both of a speed and steering of the vehicle, for example. Examples of driving control of the vehicle include various types of driving control, such as an adaptive cruise control system (ACC), a traffic jam pilot (TJP), an automatic lane changing system (ALC), a collision mitigation brake system (CMBS), and a lane keeping assistance system (LKAS). An automated driving vehicle may also be controlled by manual driving by the occupant (driver). In the following description, description is provided with a case where left-hand traffic regulations are applied. However, when right-hand traffic regulations are applied, left and right terms may be reversed.

### Overall Configuration

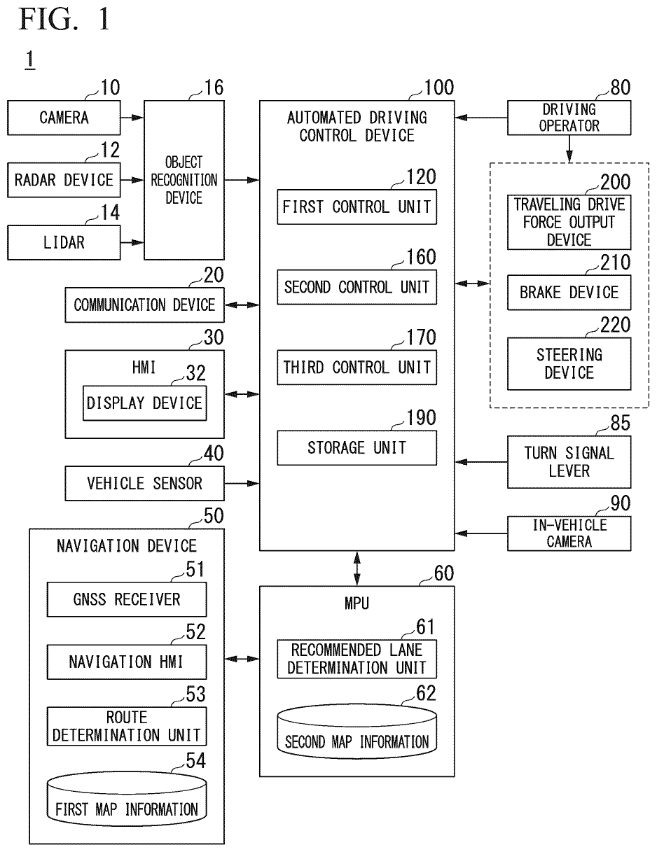

FIG. 1 is a configuration diagram of a vehicle system 1 using a display device of the embodiment. A vehicle on which the vehicle system 1 is mounted (hereinafter referred to as a host vehicle M) may be, for example, a two-wheeled, three-wheeled, or four-wheeled vehicle, and its drive source may include an internal combustion engine such as a diesel engine or gasoline engine, an electric motor, or a combination of these. The electric motor operates using power generated by a generator connected to the internal combustion engine, or discharged power from a secondary battery or fuel cell.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driving operator 80, a turn signal lever 85, an in-vehicle camera 90, an automated driving control device 100, a traveling drive force output device 200, a brake device 210, and a steering device 220. These devices and apparatuses are connected to each other by a plurality of multiplexed communication lines such as a controller area network (CAN) communication line, a serial communication line, a wireless communication network, or the like. The configuration shown in FIG. 1 is merely an example, and a part of the configuration may be omitted or another configuration may be added. In particular, a combination of the HMI 30 and the automated driving control device 100 is an example of a “display device.”

The camera 10 is a digital camera that uses a solid-state image sensor such as a charge coupled device (CCD) or a complementary metal oxide semiconductor (CMOS). The camera 10 is attached to an arbitrary place in a host vehicle M. When an image of an area in front of the host vehicle M is captured, the camera 10 is attached to an upper part of the front windshield, a back surface of the windshield rear-view mirror, and the like. In addition, when an image of an area behind the host vehicle M is captured, the camera 10 may be attached to a top of the rear windshield, and the like. When an image of an area on the right or left side of the host vehicle M is captured, the camera 10 may be attached to the right side, left side, or the like of the vehicle body or door mirror. The camera 10 periodically and repeatedly captures, for example, a periphery of the host vehicle M. The camera 10 may be a stereo camera.

The radar device 12 radiates radio waves such as millimeter waves to the periphery of the host vehicle M, and also detects at least a position (a distance and an orientation) of an object by detecting radio waves (reflected waves) reflected by the object. The radar device 12 is attached to an arbitrary place on the host vehicle M. The radar device 12 may detect the position and speed of an object in a frequency modulated continuous wave (FM-CW) method.

The LIDAR 14 emits light to a periphery of the host vehicle M and measures scattered light of the emitted light. The LIDAR 14 detects a distance to a target based on a time from light emission to light reception. The emitted light may be, for example, a pulsed laser beam. The LIDAR 14 is attached to an arbitrary place on the host vehicle M.

The object recognition device 16 performs sensor fusion processing on a result of detection by some or all of the camera 10, the radar device 12, and the LIDAR 14, and recognizes the position, type, speed, and the like of an object. The object recognition device 16 outputs a result of recognition to the automated driving control device 100. The object recognition device 16 may output the results of detection by the camera 10, the radar device 12, and the LIDAR 14 to the automated driving control device 100 as they are. The object recognition device 16 may be omitted from the vehicle system 1.

The communication device 20 communicates with other vehicles present in the periphery of the host vehicle M by using, for example, a cellular network, a Wi-Fi network, Bluetooth (a registered trademark, omitted below), dedicated short range communication (DSRC), or the like, or communicates with various server devices via a wireless base station.

The HMI 30 presents various types of information to the occupant of the host vehicle M and receives an input operation from the occupant. For example, the HMI 30 includes a display device 32. The display device 32 includes, for example, a first display 32A and a second display 32B. The HMI 30 may also include a speaker, buzzer, touch panel, microphone, and the like.

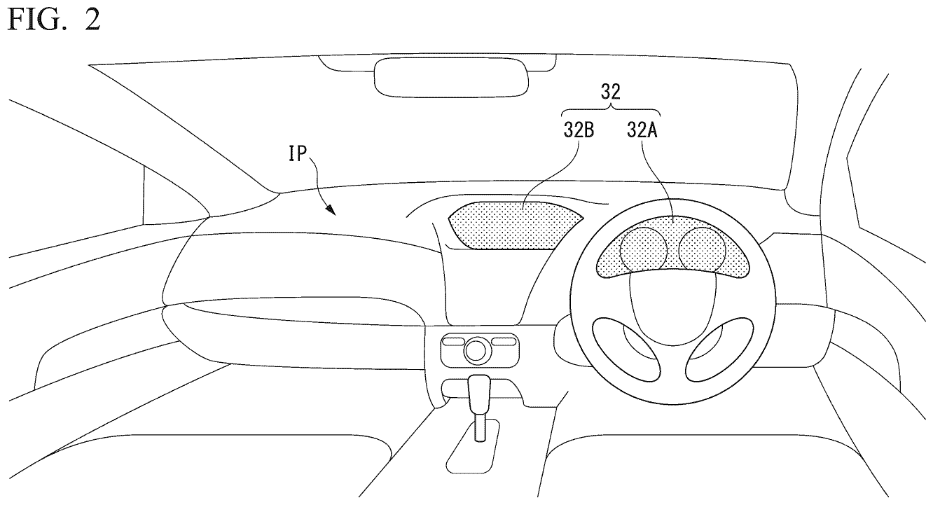

FIG. 2 is a diagram which schematically shows an interior of the host vehicle M. For example, the first display 32A is provided near a front of the driver's seat (a seat closest to the steering wheel) in an instrument panel IP, and is installed in a position that allows the occupant to visually recognize it through a gap in the steering wheel or over the steering wheel.

The first display 32A is, for example, a liquid crystal display (LCD) or an organic electro luminescence (EL) display device. Information necessary for traveling of the host vehicle M during manual driving or driving assistance is displayed as an image on the first display 32A. Information necessary for traveling of the host vehicle M during manual driving includes, for example, a speed, an engine RPM, a remaining fuel, a radiator water temperature, a mileage, a remaining battery charge, and other information of the host vehicle M. Information necessary for traveling of the host vehicle M during driving assistance includes, for example, a future trajectory of the host vehicle M (a target trajectory which will be described below), a presence or absence of a lane change and a lane to which a lane change will occur, recognized lanes (marking lines), and other vehicles. Moreover, the information necessary for traveling of the host vehicle M during driving assistance may include some or all of the information necessary for traveling of the host vehicle M during manual driving. The first display 32A is an example of a “display.”

The second display 32B is installed, for example, near a center of the instrument panel IP. Like the first display 32A, the second display 32B is, for example, an LCD or organic EL display device. The second display 32B displays, for example, navigation results of the navigation device 50 as an image. The second display 32B may also display television programs, play DVDs, or display downloaded content such as movies.

Sizes of the screens of the first display 32A and the second display 32B cannot be increased without limit and are limited depending on a vehicle type and a model of the host vehicle M (for example, an entry-level model, a high-end model, and the like). In particular, a size of a screen of the first display 32A tends to be relatively small so as not to obstruct forward visibility of the occupant or to keep the vehicle price low.

The vehicle sensor 40 includes a vehicle speed sensor that detects a speed of the host vehicle M, an acceleration sensor that detects acceleration, a yaw rate sensor that detects an angular speed around a vertical axis, an azimuth sensor that detects a direction of the host vehicle M, and the like.

The navigation device 50 includes, for example, a global navigation satellite system (GNSS) receiver 51, a navigation HMI 52, and a route determination unit 53. The navigation device 50 holds first map information 54 in a storage device such as a hard disk drive (HDD) or a flash memory.

The GNSS receiver 51 identifies a position of the host vehicle M based on a signal received from a GNSS satellite. The position of the host vehicle M may be identified or complemented by an inertial navigation system (INS) using an output of the vehicle sensor 40.

The navigation HMI 52 includes a display device, a speaker, a touch panel, a key, and the like. The navigation HMI 52 may be partially or entirely shared with the HMI 30 described above. For example, instead of or in addition to inputting a destination of the host vehicle M to the HMI 30, the occupant may input the destination of the host vehicle M to the navigation HMI 52.

The route determination unit 53 determines, for example, a route from the position of the host vehicle M (or an arbitrary position to be input) identified by the GNSS receiver 51 to a destination to be input by the occupant using the HMI 30 or the navigation HMI 52 (hereinafter, referred to as a route on a map) with reference to the first map information 54.

The first map information 54 is, for example, information in which a road shape is expressed by a link indicating a road and nodes connected by a link. The first map information 54 may include a road curvature, point of interest (POI) information, and the like. A route on a map is output to the MPU 60.

The navigation device 50 may perform route guidance using the navigation HMI 52 based on the route on a map. The navigation device 50 may be realized by, for example, a function of a terminal device such as a smartphone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determination unit 61, and holds second map information 62 in a storage device such as an HDD or a flash memory. The recommended lane determination unit 61 divides the route on a map provided from the navigation device 50 into a plurality of blocks (for example, divides every 100 min a vehicle traveling direction), and determines a recommended lane for each block with reference to the second map information 62.

A recommended lane is a lane in which the host vehicle M is recommended to travel among one or more lanes formed on the road on which the host vehicle M is present. The recommended lane may also be read as a target lane.

The recommended lane determination unit 61 determines which numbered lane from the left to drive. When a branch place is present on the route on a map, the recommended lane determination unit 61 determines a recommended lane so that the host vehicle M can travel on a reasonable route to proceed to the branch destination.

The second map information 62 is map information with higher accuracy than the first map information 54. The second map information 62 includes, for example, information on a center of a lane, information on a boundary of the lane, and the like. In addition, the second map information 62 may include road information, traffic regulation information, address information (addresses/zip codes), facility information, telephone number information, and the like. The second map information 62 may be updated at any time by the communication device 20 communicating with another device.

The driving operator 80 includes, for example, an accelerator pedal, a brake pedal, a shift lever, a steering wheel, differential steering, a joystick, and other operators. The driving operator 80 has a sensor that detects the amount of operation or a presence or absence of an operation attached thereto, and a result of detection is output to the automated driving control device 100, or some or all of the traveling drive force output device 200, the brake device 210, and the steering device 220.

For example, a sensor attached to the steering wheel (hereinafter referred to as a “steering sensor”) detects a weak current (for example, a change in capacitance) generated when the occupant touches the steering wheel. In addition, the steering sensor may detect steering torque generated around a rotation axis (shaft) of the steering wheel. When the steering sensor detects the current or steering torque, it outputs a signal indicating a result of the detection to the automated driving control device 100.

When the turn signal lever 85 (also called a stalk or switch) is operated by the occupant, it turns on lamps attached to front and rear of the host vehicle M. In addition, the turn signal lever 85 is operated to instruct the host vehicle M to change lanes. Operating the turn signal lever 85 to instruct a lane change is also referred to as a one-touch function. Hereinafter, operating the turn signal lever 85 to instruct a lane change is referred to as a “lane change instruction operation.”

In addition to, or instead of, operating the turn signal lever 85, the lane change instruction may be performed by inputting voice into a microphone, or by operating another switch or button.

The in-vehicle camera 90 is a camera that captures an image of the interior of the host vehicle M. The in-vehicle camera 90 is, for example, a digital camera that uses a solid-state image sensor such as a CCD or CMOS. After the image of the interior of the host vehicle M is captured, the in-vehicle camera 90 outputs image data to the automated driving control device 100.

The automated driving control device 100 includes, for example, a first control unit 120, a second control unit 160, a third control unit 170, and a storage unit 190. The first control unit 120, the second control unit 160, and the third control unit 170 are realized by, for example, a hardware processor such as a central processing unit (CPU) or a graphics processing unit (GPU) executing a program (software), respectively. Some or all of these components may be realized by hardware (a circuit unit; including circuitry) such as large scale integration (LSI), an application specific integrated circuit (ASIC), a field-programmable gate array (FPGA), or a system on chip (SOC), or may be realized by software and hardware in cooperation. A program may be stored in advance in a storage device (a storage device having a non-transitory storage medium) such as an HDD or flash memory of the automated driving control device 100, or may be stored in a detachable storage medium such as a DVD or a CD-ROM and installed in the HDD or flash memory of the automated driving control device 100 by the storage medium (non-transitory storage medium) being attached to a drive device.

The storage unit 190 is realized by various storage devices described above. The storage unit 190 is realized by, for example, an HDD, a flash memory, an electrically erasable programmable read only memory (EEPROM), a read only memory (ROM), or a random access memory (RAM). The storage unit 190 stores, for example, programs (instructions) that are read and executed by a processor.

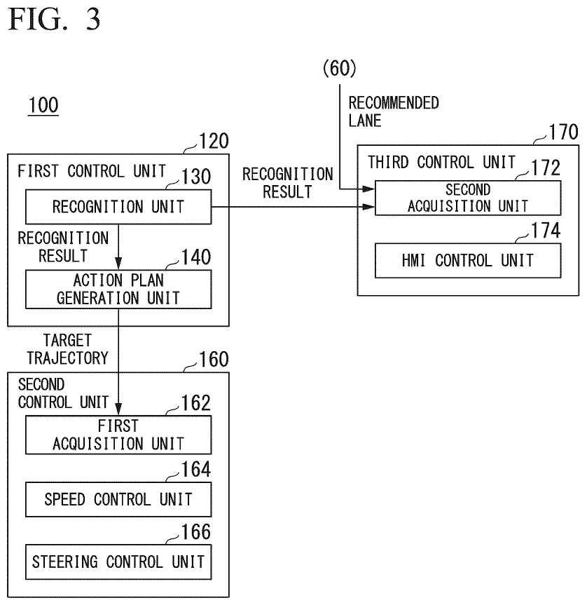

FIG. 3 is a functional configuration diagram of the first control unit 120, the second control unit 160, and the third control unit 170. The first control unit 120 includes, for example, the recognition unit 130, and the action plan generation unit 140.

The first control unit 120 realizes, for example, a function by artificial intelligence (AI) and a function of a predetermined model in parallel. For example, a function of “recognizing an intersection” may be realized by executing both recognition of an intersection by deep learning and recognition based on a predetermined condition (a signal for pattern matching, a road sign, or the like) in parallel, and scoring and comprehensively evaluating the both. As a result, reliability of automated driving is ensured.

The recognition unit 130 recognizes a situation or an environment in a periphery of the host vehicle M. The recognition unit 130 recognizes objects in the periphery of the host vehicle M on the basis of information input from the camera 10, the radar device 12, and the LIDAR 14 via the object recognition device 16. The objects recognized by the recognition unit 130 includes, for example, bicycles, motorcycles, four-wheeled vehicles, pedestrians, road signs, road markings, marking lines, utility poles, guardrails, fallen objects, and the like. In addition, the recognition unit 130 recognizes states, such as positions, speeds, and accelerations, of the objects. The positions of the objects are recognized as, for example, positions on relative coordinates with a representative point (a center of gravity, a center of a drive axis, or the like) of the host vehicle M as an origin, and are used for control. The position of an object may be represented by a representative point such as the center of gravity or a corner of the object, or may be represented by an expressed area. The “states” of an object may include an acceleration or jerk of the object, or a “behavioral state” (for example, whether a lane is being changed or is about to be changed).

In addition, the recognition unit 130 recognizes, for example, a lane (hereinafter, referred to as a host lane) in which the host vehicle M is traveling, other lanes adjacent to the host lane (hereinafter, referred to as adjacent lanes), and the like. For example, the recognition unit 130 recognizes the host lane, adjacent lanes, and the like by comparing a pattern of road marking lines (for example, an arrangement of solid and dashed lines) obtained from the second map information 62 with a pattern of road marking lines around the host vehicle M recognized from an image captured by the camera 10.

In addition, the recognition unit 130 may recognize lanes, such as the host lane and adjacent lanes, by recognizing traveling road boundaries (road boundaries) including road marking lines, road shoulders, curbs, medians, guardrails, and the like, not limited to road marking lines. This recognition may also include the position of the host vehicle M acquired from the navigation device 50 and a result of processing by the INS. Moreover, the recognition unit 130 may recognize stop lines, obstacles, red lights, toll booths, and other road phenomena.

The recognition unit 130 recognizes a relative position and posture of the host vehicle M with respect to the host lane when the host lane is recognized. The recognition unit 130 may recognize, for example, a deviation of a reference point of the host vehicle M from a center of the lane and an angle of the host vehicle M, formed with respect to a line connecting centers of the lane in the traveling direction, as the relative position and posture of the host vehicle M with respect to the host lane. Instead, the recognition unit 130 may recognize a position or the like of the reference point of the host vehicle M with respect to any side end (a road marking line or road boundary) of the host lane as the relative position of the host vehicle M with respect to the host lane.

When the host vehicle M is in automated driving on a route for which a recommended lane has been determined, the action plan generation unit 140 determines a traveling mode of the automated driving. Hereinafter, information specifying the traveling mode of the automated driving will be referred to as an event.

Events include, for example, a constant speed traveling event, a following traveling event, a lane change event, a branch event, a merging event, a takeover event, and the like. A constant speed event is a traveling mode in which the host vehicle M travels at a constant speed in the same lane. A following traveling event is a traveling mode in which the host vehicle M follows another vehicle (hereinafter referred to as a preceding vehicle) that is present within a specified distance (for example, within 100 meters) ahead of the host vehicle M in the host lane and is closest to the host vehicle M. “Following” may refer to, for example, a traveling mode in which an inter-vehicle distance (relative distance) between the host vehicle M and the preceding vehicle is maintained to be constant, or a traveling mode in which the host vehicle M is caused to travel in a center of the host lane in addition to maintaining the constant inter-vehicle distance between the host vehicle M and the preceding vehicle.

A lane change event is a traveling mode in which the host vehicle M changes lanes from the host lane to an adjacent lane. A branch event is a traveling mode in which the host vehicle M is caused to branch off into a lane on a destination side at a road branch point. A merge event is a traveling mode in which the host vehicle M is caused to merge onto a main lane at a merge point. A takeover event is a traveling mode in which automated driving is terminated and is switched to manual driving.

In addition, events may include, for example, an overtaking event and an avoidance event. An overtaking event is a traveling mode in which the host vehicle M is caused to first change lanes to an adjacent lane, overtake a preceding vehicle in the adjacent lane, and then changes lanes back to an original lane. An avoidance event is a traveling mode in which the host vehicle M performs at least one of braking and steering to avoid an obstacle ahead of the host vehicle M.

Furthermore, the action plan generation unit 140 may change an event already determined for a current section to another event, or determine a new event for the current section, depending on the surrounding conditions recognized by the recognition unit 130 while the host vehicle M is traveling.

Moreover, the action plan generation unit 140 may determine an event depending on an operation of the occupant on the turn signal lever 85 (or a switch, button, or the like that serves as an alternative thereto). For example, when the occupant operates the turn signal lever 85 to instruct a left turn, the action plan generation unit 140 determines a lane change event that causes the host vehicle M to change lanes to an adjacent lane on the left as seen from the host vehicle M. Also, when the occupant operates the turn signal lever 85 to instruct a right turn, the action plan generation unit 140 determines a lane change event that causes the host vehicle M to change lanes to an adjacent lane on the right as seen from the host vehicle M.

In principle, the action plan generation unit 140 causes the host vehicle M to travel in a recommended lane determined by the recommended lane determination unit 61. Furthermore, to respond to surrounding conditions while the host vehicle M is traveling in the recommended lane, the action plan generation unit 140 generates a future target trajectory that causes the host vehicle M to travel automatically (without relying on an operation of the driver) in a traveling mode specified by an event. The target trajectory includes, for example, a position element that determines a future position of the host vehicle M and a speed element that determines a future speed of the host vehicle M.

For example, the action plan generation unit 140 determines a plurality of points (trajectory points) that the host vehicle M needs to reach in sequence as position elements of the target trajectory. Trajectory points are points that the host vehicle M needs to reach every predetermined traveling distance (for example, about several meters [m]). The predetermined traveling distance may be calculated, for example, based on a distance traveled along a route.

Moreover, the action plan generation unit 140 determines a target speed and target acceleration for every predetermined sampling time (for example, about a few tenths of a second [sec]) as the speed elements of the target trajectory. Furthermore, the trajectory points may be positions that the host vehicle M needs to reach at a corresponding sampling time for every predetermined sampling time. In this case, the target speed and target acceleration are determined by a sampling time and an interval between trajectory points. The action plan generation unit 140 outputs information indicating the generated target trajectory to the second control unit 160.

The second control unit 160 controls the traveling drive force output device 200, the brake device 210, and the steering device 220 so that the host vehicle M passes through a target trajectory generated by the action plan generation unit 140 at a scheduled time.

The second control unit 160 includes, for example, a first acquisition unit 162, a speed control unit 164, and a steering control unit 166.

The first acquisition unit 162 acquires information on a target trajectory (trajectory points) from the action plan generation unit 140 and stores it in a memory of the storage unit 190.

The speed control unit 164 controls one or both of the traveling drive force output device 200 and the brake device 210 on the basis of a speed element (for example, a target speed, a target acceleration, or the like) included in the target trajectory stored in the memory.

The steering control unit 166 controls the steering device 220 according to position elements (for example, curvature which indicates a degree of bending of the target trajectory) included in the target trajectory stored in the memory.

Processing of the speed control unit 164 and the steering control unit 166 is realized by, for example, a combination of feedforward control and feedback control. As an example, the steering control unit 166 executes feedforward control according to a curvature of a road in front of the host vehicle M and feedback control based on a deviation from the target trajectory in combination.

The traveling drive force output device 200 outputs a traveling drive force (torque) for the vehicle to travel to the drive wheels. The traveling drive force output device 200 includes, for example, a combination of an internal combustion engine, a motor, a transmission, and the like, and a power electronic control unit (ECU) that controls these. The power ECU controls the configuration described above according to information input from the second control unit 160 or information input from the driving operator 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor according to the information input from the second control unit 160 or the information input from the driving operator 80 so that a brake torque according to a braking operation is output to each wheel. The brake device 210 may include a mechanism for transmitting a hydraulic pressure generated by an operation of a brake pedal included in the driving operator 80 to the cylinder via a master cylinder as a backup. The brake device 210 is not limited to the configuration described above, and may be an electronically controlled hydraulic brake device that controls an actuator according to the information input from the second control unit 160 to transmit the hydraulic pressure of the master cylinder to the cylinder.

The steering device 220 includes, for example, a steering ECU and an electric motor. The electric motor changes, for example, a direction of a steering wheel by applying a force to a rack and pinion mechanism. The steering ECU drives the electric motor according to the information input from the second control unit 160 or the information input from the driving operator 80, and changes the direction of the steering wheel.

The third control unit 170 includes a second acquisition unit 172 and an HMI control unit 174.

The second acquisition unit 172, for example, acquires a result of recognition from the recognition unit 130 or acquires information on a recommended lane determined by the MPU 60. The second acquisition unit 172 provides various types of acquired information to the HMI control unit 174.

The HMI control unit 174 controls the HMI 30 based on various types of information acquired by the second acquisition unit 172. The HMI control unit 174 is an example of a “display control unit.”

For example, the HMI control unit 174 may display at least the host lane and adjacent lanes among the plurality of lanes recognized by the recognition unit 130 on the first display 32A, display marking lines of each of the host lane and the adjacent lanes on the first display 32A, and display the host vehicle M, whose position relative to the host lane has been recognized, on the first display 32A.

Furthermore, the HMI control unit 174 may display a lane change guide LCG on the first display 32A.

The lane change guide LCG is a guide that guides the occupant of the host vehicle M to the position of the recommended lane determined by the MPU 60 (more specifically, a relative position of the recommended lane with respect to other lanes). For example, the lane change guide LCG may be represented by a plurality of arrows arranged in an extending direction of the lane. The lane change guide LCG is an example of the “guidance information.”

For example, the HMI control unit 174 determines a position of the lane change guide LCG to be displayed on the first display 32A based on the number of scheduled lane changes.

The number of scheduled lane changes refers to the minimum number of lane changes required for the host vehicle M to move from the host lane to the recommended lane.

### Processing Flow

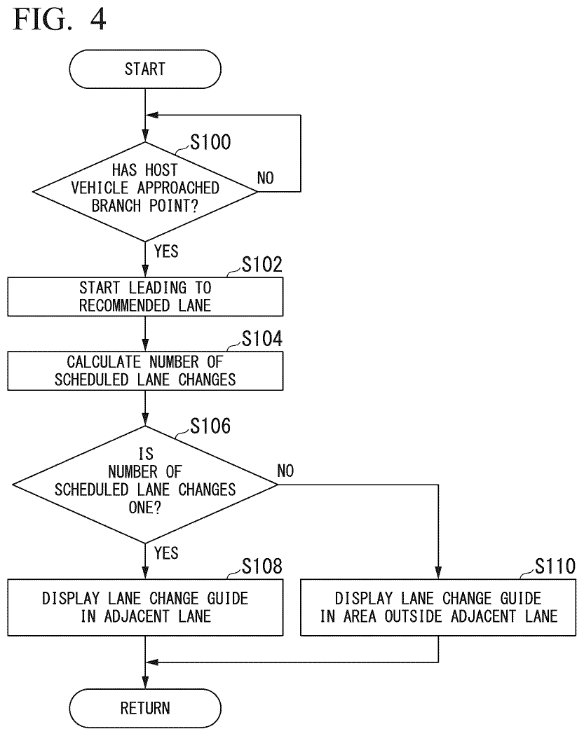

The following describes a flow of a series of processing performed by the automated driving control device 100 according to the present embodiment using a flowchart. FIG. 4 is a flowchart which shows an example of the flow of the series of processing performed by the automated driving control device 100 according to the present embodiment. The processing of this flowchart may be executed repeatedly at a predetermined interval, for example, when the host vehicle M is traveling on a main road on which a plurality of lanes are formed.

First, the HMI control unit 174 determines whether the host vehicle M has approached a predetermined branch point (step S100). The predetermined branch point is a point where a lane branches off from a main road, and a destination is present beyond the lane that branches off from the main road (hereinafter referred to as a branch lane). In other words, the predetermined branch point is a point where the host vehicle M needs to change lanes from the main road to the branch lane.

When the host vehicle M approaches the predetermined branch point, the HMI control unit 174 uses the HMI 30 to start leading the host vehicle M to a recommended lane at the predetermined branch point (step S102).

For example, to lead the host vehicle M from the host lane to the recommended lane, the HMI control unit 174 displays a host lane, adjacent lanes, marking lines, and a lane change guide LCG on the first display 32A of the HMI 30.

Next, the HMI control unit 174 calculates the number of scheduled lane changes on the basis of a relative position of the host lane with respect to the plurality of lanes and a relative position of the recommended lane with respect to the plurality of lanes (step S104).

Next, the HMI control unit 174 determines whether the number of scheduled lane changes is one, or two or more (step S106). In other words, the HMI control unit 174 determines whether an adjacent lane is the recommended lane.

When the number of scheduled lane changes is one, i.e., when an adjacent lane is the recommended lane and the host vehicle M can move from the host lane to the recommended lane using one lane change, the HMI control unit 174 displays a lane change guide LCG on the adjacent lane displayed on the first display 32A (step S108).

On the other hand, when the number of scheduled lane changes is two or more, i.e., when an adjacent lane is not the recommended lane and the host vehicle M can move from the host lane to the recommended lane using two or more lane changes, the HMI control unit 174 displays a lane change guide LCG on an area outside the adjacent lane displayed on the first display 32A (step S110).

### Case Where There Are Two Scheduled Lane Changes

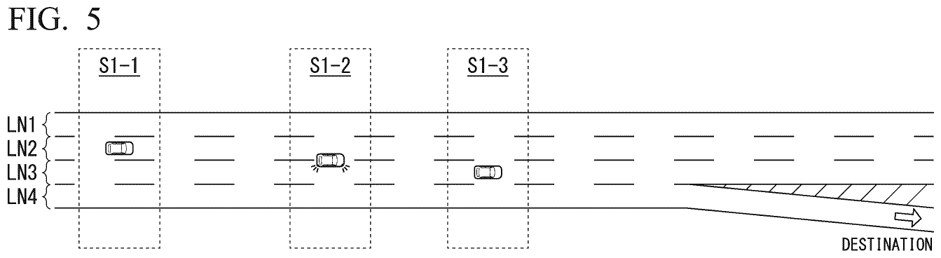

FIG. 5 shows an example of a situation in which a predetermined branch point is present ahead of the host vehicle M traveling on a main road. In the shown example, the main road on which the host vehicle M is traveling has four lanes LN1 to LN4, with a lane LN4 positioned on a rightmost side being the branch lane. A destination is present beyond the lane LN4. In this situation, the lane LN4 is determined to be the recommended lane to enable rational branching.

The situation shown in FIG. 5 can be divided into several scenes S1-1, S1-2, and S1-3. In the scene S1-1, the host vehicle M is traveling in a lane LN2. In the scene S1-2, the host vehicle M starts to change lanes and the host vehicle M is present between the host lane LN2 and an adjacent lane LN3. In the scene S1-3, the host vehicle M has completed the lane change and is traveling in the lane LN3.

For example, in the scene S1-1, at least two lane changes are required for the host vehicle M to move from the host lane LN2 to a recommended lane LN4. Therefore, the number of scheduled lane changes is two.

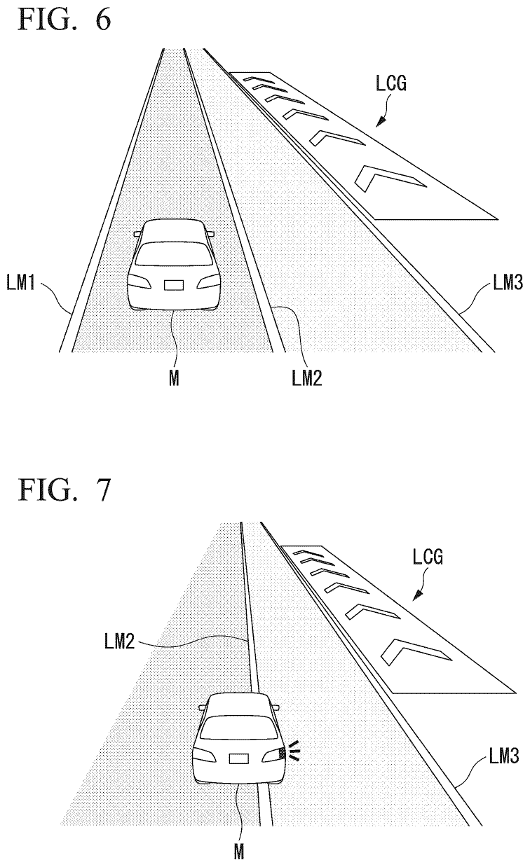

FIG. 6 is a diagram which shows an example of the screen of the first display 32A in the scene S1-1. In FIG. 6, LM1 represents a left marking line of the host lane LN2, in which the host vehicle M is present. LM2 represents a marking line separating the host lane LN2 from the adjacent lane LN3. LM3 represents a right marking line of the adjacent lane LN3.

In the scene S1-1, the number of scheduled lane changes is two. For this reason, the HMI control unit 174 displays the host vehicle M on the first display 32A, while displaying marking lines LM1 to LM3 for the host lane LN2 and the adjacent lane LN3. The HMI control unit 174 then displays a lane change guide LCG on an area outside the adjacent lane LN3 displayed on the first display 32A.

As shown in FIG. 6, the area outside the adjacent lane LN3 includes, as seen from the host vehicle M, an area to a left of the marking line LM2, which forms the adjacent lane LN3, and an area to a right of the marking line LM3, which forms the adjacent lane LN3. The area to the left of the marking line LM2 is an area where the host lane LN2 is present. In this case, the lane change guide LCG is displayed to be superimposed on the area to the right of the marking line LM3 where the host lane is not present.

FIG. 7 is a diagram which shows an example of the screen of the first display 32A in the scene S1-2. The lane change in the scene S1-2 is more advanced than in the scene S1-1. For this reason, the HMI control unit 174 moves the marking lines LM2 and LM3 relatively to the host vehicle M on the first display 32A in response to the lane change. At this time, the HMI control unit 174 also moves the lane change guide LCG relatively to the host vehicle M. As shown in the example shown, when the position of the host vehicle M does not change, the marking lines LM2 and LM3 move to the left relative to the position of the host vehicle M, and the lane change guide LCG also moves to the left relative to the position of the host vehicle M. However, the lane change guide LCG continues to be displayed on the area to the right of the marking line LM3.

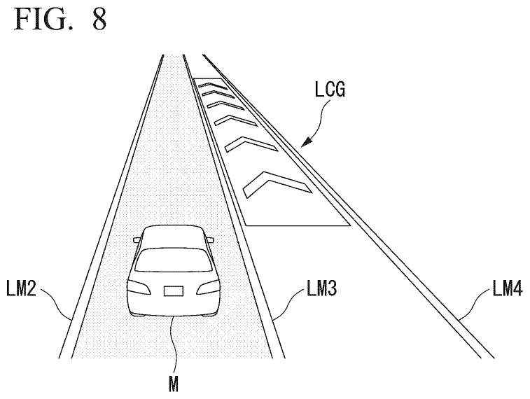

FIG. 8 is a diagram which shows an example of the screen of the first display 32A in the scene S1-3. In the scene S1-3, the host vehicle M has completed one lane change. Therefore, the lane LN3, which has been the adjacent lane in the S1-1, becomes the host lane in the scene S1-3, and the recommended lane LN4 becomes an adjacent lane of the host lane LN3 in the scene S1-3.

In the scene S1-3, the HMI control unit 174 moves the marking lines LM2 and LM3 relatively to the host vehicle M on the first display 32A, and also displays a new marking line LM4. At this time, the HMI control unit 174 calculates a difference between the number of scheduled lane changes and the number of times lane changes are executed (hereinafter referred to as the number of executed lane changes). When the difference is one, the HMI control unit 174 moves the lane change guide LCG, which has been displayed on the area outside the adjacent lane, to the adjacent lane.

The number of executed lane changes from the scene S1-1 to S1-3 is one. For this reason, the difference between the number of scheduled lane changes and the number of executed lane changes is one. This is clear based on a fact that the recommended lane LN4 is an adjacent lane of the host lane LN3 in the scene S1-3. For this reason, the HMI control unit 174 displays the lane change guide LCG on the adjacent lane LN4, as shown in FIG. 8. This makes it possible to clearly inform the occupant that there is only one lane change remaining to move the host vehicle M to the recommended lane.

### Case Where There Are Three Scheduled Lane Changes

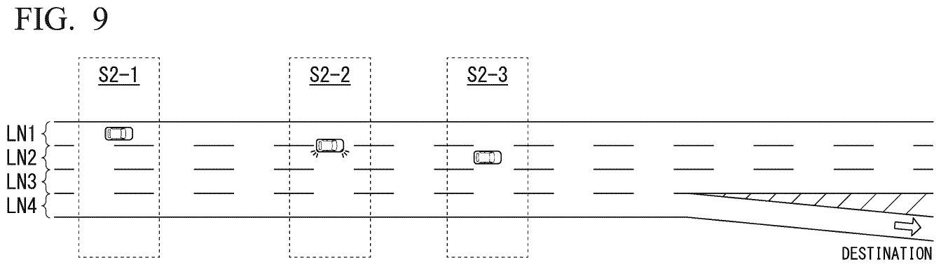

FIG. 9 is a diagram which shows another example of a situation in which a predetermined branch point is present ahead of the host vehicle M traveling on the main road. Because the destination is present beyond the lane LN4, the lane LN4 is determined to be the recommended lane in the situation shown in FIG. 9 to enable rational branching.

In the scene S2-1 in the FIG. 9, the host vehicle M is traveling in the lane LN1. In a scene S2-2, the host vehicle M has started a lane change and is present between the host lane LN1 and the adjacent lane LN2. In a scene S2-3, the host vehicle M has completed the lane change and is traveling in the lane LN2.

For example, in a scene S2-1, at least three lane changes are required to move the host vehicle M from the host lane LN1 to the recommended lane LN4. Therefore, the number of scheduled lane changes is three.

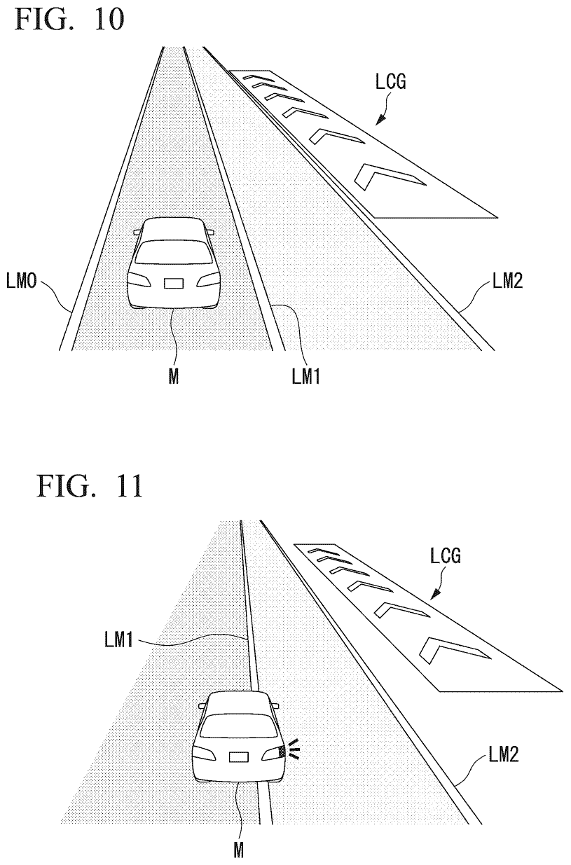

FIG. 10 is a diagram which shows an example of the screen of the first display 32A in the scene S2-1. In FIG. 10, LM0 represents a marking line on a left side of the host lane LN1, in which the host vehicle M is present. LM1 represents a marking line separating the host lane LN1 from the adjacent lane LN2. LM2 represents a marking line on a right side of the adjacent lane LN2.

In the scene S2-1, the number of scheduled lane changes is three. For this reason, the HMI control unit 174 displays the host vehicle M on the first display 32A, while displaying the marking lines LM0 to LM2 of each of the host lane LN1 and the adjacent lane LN2. The HMI control unit 174 then displays the lane change guide LCG in an area outside the adjacent lane LN2 displayed on the first display 32A.

FIG. 11 is a diagram which shows an example of the screen of the first display 32A in the scene S2-2. Compared to the scene S2-1, a lane change in the scene S2-2 is more advanced. For this reason, the HMI control unit 174 moves the marking lines LM1 and LM2 relatively to the host vehicle M on the first display 32A in response to the lane change. At this time, the HMI control unit 174 does not move the lane change guide LCG.

Note that even in a scene where the number of lane changes decreases from three to two, the HMI control unit 174 may also slightly move the lane change guide LCG relatively to the host vehicle M to inform the occupant of the lane change, and then return the lane change guide LCG to a separate position when a first lane change is completed.

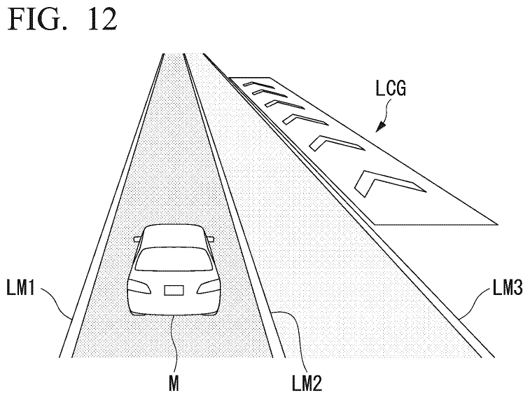

FIG. 12 is a diagram which shows an example of the screen of the first display 32A in the scene S2-3. In the scene S2-3, the host vehicle M has completed one lane change. Therefore, the lane LN2, which has been an adjacent lane in S2-1, becomes a host lane in the scene S2-3, and the lane LN3 becomes an adjacent lane of the host lane LN2 in the scene S2-3. To move the host vehicle M to the recommended lane LN4, two remaining lane changes are required, as shown in the shown situation in FIG. 5.

In the scene S2-3, the HMI control unit 174 moves the marking lines LM1 and LM2 relatively to the host vehicle M on the first display 32A, while newly displaying a marking line LM3. At this time, the HMI control unit 174 calculates the difference between the number of scheduled lane changes and the number of executed lane changes. When the difference is one, it moves the lane change guide LCG, which has been displayed in an area outside the adjacent lane, into the adjacent lane.

The number of executed lane changes from the scene S2-1 to S2-3 is one. For this reason, the difference between the number of scheduled lane changes and the number of executed lane changes is two. For this reason, as shown in FIG. 11, the HMI control unit 174 does not move the lane change guide LCG into the adjacent lane LN3, but continues to display it in the area outside the adjacent lane LN3.

In other words, when the number of scheduled lane changes is three, the HMI control unit 174 causes the position of the lane change guide LCG displayed on the first display 32A after the first lane change is executed by the host vehicle M to be the same as the position of the lane change guide LCG displayed on the first display 32A before the first lane change is executed. In this manner, by not moving the position of the lane change guide LCG on the first display 32A, it is possible to clearly inform the occupant that there are still a plurality of lane changes remaining to move the host vehicle M into the recommended lane, without providing excessive visual information to the occupant.

According to the embodiment described above, the automated driving control device 100 displays the host lane, adjacent lanes, and the lane change guide LCG (an example of the guidance information) on the first display 32A. Furthermore, the automated driving control device 100 determines the position of the lane change guide LCG to be displayed on the first display 32A based on the number of scheduled lane changes. When the number of scheduled lane changes is one, the lane change guide LCG is displayed on an adjacent lane. When the number of scheduled lane changes is two or more, the lane change guide LCG is displayed on an area outside the adjacent lane. With such a configuration, it is possible to provide occupants with clear guidance to a position of a recommended lane while making maximum effective use of the screen of the first display 32A, which has a limited size. Furthermore, since the number of lanes displayed on the first display 32A can be reduced compared to the number of lanes actually present on a road, widths of the lanes displayed on the first display 32A can also be increased.

### Other Embodiments

Other embodiments are described below. In the embodiment described above, the host lane, adjacent lanes, and the lane change guide LCG are displayed on the first display 32A, but the present invention is not limited thereto. The host lane, adjacent lanes, and lane change guide LCG may be displayed on the second display 32B instead of the first display 32A, or may be displayed on another display device (for example, a head-up display).

Although a mode for carrying out the present invention has been described above using the embodiment, the present invention is not limited to the embodiment, and various modifications and substitutions can be made within a range not departing from the gist of the present invention.

What is claimed is:

1. A display device comprising:
a display; and
a display control unit configured to display surrounding conditions of a vehicle on the display,
wherein the display control unit executes:
displaying on the display, as the surrounding conditions, among a plurality of lanes formed on a road on which the vehicle is present, a host lane that is a lane in which the vehicle is present, an adjacent lane that is a lane adjacent to the host lane, and guidance information for guiding an occupant of the vehicle to a position of a recommended lane, which is a lane in which the vehicle is recommended to travel,
determining a position of the guidance information to be displayed on the display based on the number of scheduled lane changes, which is the number of lane changes scheduled to be performed before the vehicle is moved from the host lane to the recommended lane,
displaying the guidance information on the adjacent lane when the number of scheduled lane changes is one, and
displaying the guidance information in an area outside the adjacent lane where the host lane is not present when the number of scheduled lane changes is two or more.

2. The display device according to claim 1,
wherein the display control unit continues to display the guidance information in the area regardless of the number of lane changes when the number of scheduled lane changes is two or more.

3. The display device according to claim 2,
wherein the display control unit, when the number of scheduled lane changes is three or more, causes the position of the guidance information displayed on the display after a first lane change is executed by the vehicle to be the same as the position of the guidance information displayed on the display before the first lane change is executed by the vehicle.

4. The display device according to claim 3,
wherein the display control unit displays the guidance information on the adjacent lane when a difference between the number of scheduled lane changes and the number of executed lane changes, which is the number of times the lane change is executed by the vehicle, is one.

5. The display device according to claim 4,
wherein the display control unit further displays marking lines of each of the host lane and the adjacent lane and the vehicle on the display,
moves the marking lines on the display as the lane change is executed by the vehicle,
moves the marking lines and the guidance information when the number of scheduled lane changes is two and the difference between the number of scheduled lane changes and the number of executed lane changes is one, and
moves the marking lines while guidance information is not moved when the number of scheduled lane changes is three or more and the difference between the number of scheduled lane changes and the number of executed lane changes is two or more.

6. A display method using a computer mounted in a vehicle including a display, comprising:
displaying surrounding conditions of the vehicle on the display;
displaying on the display, as the surrounding conditions, among a plurality of lanes formed on a road on which the vehicle is present, a host lane that is a lane in which the vehicle is present, an adjacent lane that is a lane adjacent to the host lane, and guidance information for guiding an occupant of the vehicle to a position of a recommended lane, which is a lane in which the vehicle is recommended to travel;
determining a position of the guidance information to be displayed on the display based on the number of scheduled lane changes, which is the number of lane changes scheduled to be performed before the vehicle is moved from the host lane to the recommended lane;
displaying the guidance information on the adjacent lane when the number of scheduled lane changes is one; and
displaying the guidance information in an area outside the adjacent lane where the host lane is not present when the number of scheduled lane changes is two or more.

7. A non-transitory storage medium which has stored a program for causing a computer mounted in a vehicle including a display to execute:
displaying surrounding conditions of the vehicle on the display;
displaying on the display, as the surrounding conditions, among a plurality of lanes formed on a road on which the vehicle is present, a host lane that is a lane in which the vehicle is present, an adjacent lane that is a lane adjacent to the host lane, and guidance information for guiding an occupant of the vehicle to a position of a recommended lane, which is a lane in which the vehicle is recommended to travel;
determining a position of the guidance information to be displayed on the display based on the number of scheduled lane changes, which is the number of lane changes scheduled to be performed before the vehicle is moved from the host lane to the recommended lane,
displaying the guidance information on the adjacent lane when the number of scheduled lane changes is one; and
displaying the guidance information in an area outside the adjacent lane where the host lane is not present when the number of scheduled lane changes is two or more.
